(19) United States
(12) Patent Application Publication
(10) Pub. No.: US 2006/0056634 A1
(43) Pub. Date: Mar. 16, 2006

(54) Apparatus, system and method for setting security information on wireless network

(75) Inventors: Sung-min Lee, Seoul (KR); Hyun-gyoo Yook, Seoul (KR); Seung-jae Oh, Seoul (KR); Se-hee Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/224,147

(22) Filed: Sep. 13, 2005

(30) Foreign Application Priority Data
Sep. 14, 2004 (KR) 10-2004-0073474

(51) Int. Cl. H04K 1/00

(52) U.S. Cl. 380/270

(57) ABSTRACT

An apparatus, a system and a method for setting security information on a wireless network, wherein the security information of a wireless networking apparatus is set by means of a portable device which can be used conveniently by a user, to thereby enhance the security over wireless communications. An apparatus for setting security information in a wireless network includes a limit communication module to receive encryption information sorted by an access point, a key creation module to create encryption keys based on the received encryption information or encryption information input by a user, and an authentication information creation module to create authentication information according to rules associated with the authentication information sent by the access point and stations.

### CROSS-REFERENCE TO RELATED APPLICATION

This application claims priority from Korean Patent Application No. 10-2004-0073474 filed on Sep. 14, 2004 in the Korean Intellectual Property Office, the disclosure of which is incorporated herein in their entirety by reference.

### BACKGROUND OF THE INVENTION

1. Field of the Invention

Apparatuses, systems and methods consistent with the present invention relate to setting security information on a wireless network. More particularly, the present invention relates to an apparatus, a system and a method for setting security information on a wireless network, wherein the security information of a wireless networking apparatus is set by means of a portable device which can be used conveniently by a user, to thereby enhance the security over wireless communications.

2. Description of the Related Art

Generally, an IEEE 802.11 WLAN communicates without using cables, but by means of electromagnetic (EM) waves.

The IEEE 802.11 WLAN comprises an access point (AP) which conducts a wireless and wired bridging function to transform a frame of an 802.11 network into another type of frame so as to transmit it to another network, and a station such as a notebook computer or a personal digital assistant (PDA) containing a wireless LAN device capable of interfacing with a wireless network.

When access points and stations are located in different wireless environments, an external station located close to an access point may be able to wiretap all the traffic within the wireless network. To prevent this wiretapping, security for the wireless network environment is needed.

However, it may be very difficult for an ordinary user to connect his/her computer to an access point and input security information through an interface.

Due to this difficulty, many users are using wireless LANS without setting security information associated with wireless network environments.

Conventionally, to set the wireless LAN security, a console is connected to an access point so as to set a service set identifier/wireless equivalent privacy (SSID/WEP) key or a Wi-Fi protected access-pre-shared key (WPA-PSK), and security information set in the access point is set in individual devices by use of a ‘iwconfig’ command, to thereby establish the security in a wireless network.

Through the operations described above, secure communications between an access point and stations are possible.

However, there are problems; it is very difficult to construct a secure environment for the wireless LAN security and it is not possible to transmit a key created by a predetermined wireless networking apparatus by means of a medium.

For example, when more than 10 wireless networking apparatuses are present in a wireless network, a user has to manually set security information on each apparatus. In addition, when the apparatuses within the wireless network use a variety of security algorithms and techniques, the user has to search for a suitable method for each apparatus and then set suitable security algorithms for them.

Thus, users who are not accustomed to using computers or wireless networking devices are likely to find it difficult to set up the security for the wireless devices. Because of this difficulty and the inconvenience in using the security technology, they are inclined to use their computers or devices without setting the wireless LAN security information. As a result, the security of the wireless network environment deteriorates.

Also, when a device requires user authentication, the user has to input the authentication information required by the device at an initial stage, and (s)he must memorize the authentication information.

In addition, when the user accesses any resource stored in the device, the authentication information must be input via a keyboard.

Further, a user creates and uses identification information (ID and password) that is easy to remember, thereby weakening security.

When a multiplicity of devices are present within the wireless network, if a multiplicity of different passwords are set in the individual devices, the user will have difficulty remembering them. There is even a device requesting the user to make a password by combining alphabets and numerals or special letters, which makes remembering the password more difficult.

Korean Unexamined Patent Publication No. 2004-0033159, titled “Method for Encrypting and Decrypting Data Between Wireless LAN Terminal and Access Point,” discloses a method of designating the length of an encryption key of a wireless region indicated by a tag to designate a wireless region encryption algorithm at an access point, and transmitting an actual value of the created encryption key and detecting a wireless region encryption key from a key descriptor received by the wireless LAN terminal, but it does not suggest any technology to create and set the security information directly by means of a portable device.

### SUMMARY OF THE INVENTION

An aspect of the present invention proposes to enhance security over wireless communications transmitted and received within a wireless network, by creating and distributing encryption keys different and various in length by means of a portable device.

Another aspect of the present invention proposes to set security information more conveniently on wireless networking devices, by allowing a user to set security information on the wireless networking devices by means of a portable device.

The present invention will not be limited to the technical aspects described above. Other aspects not described herein will be more definitely comprehended by those in the art from the following detailed description.

According to an aspect of the present invention, there is provided an apparatus for setting security information in a wireless network, comprising a limit communication module to receive encryption information sorted by an access point, a key creation module to create encryption keys based on the received encryption information or encryption information input by a user, and an authentication information creation module to create authentication information according to rules associated with the authentication information sent by the access point and stations.

According to another aspect of the present invention, there is provided a system for setting security information in a wireless network, comprising an access point that communicates with stations in a wireless network, and collects and sorts encryption information of the stations, a key distribution device to create encryption keys based on the encryption information sorted by the access point, and to distribute the generated encryption keys, and a station to perform communications by use of the encryption keys received from the key distribution device.

According to a further aspect of the present invention, there is provided a method of setting security information in a wireless network, comprising receiving encryption information from an access point, creating encryption keys based on the received encryption information, distributing the generated encryption keys to the access point and the station, and setting the security information with the distributed encryption keys.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a system to set security information over a wireless network according to the present invention;

FIG. 2 is a block diagram illustrating an internal structure of a key distribution device in a system to set security information over a wireless network according to an exemplary embodiment of the present invention;

FIG. 3 is a block diagram illustrating an internal structure of an access point in a system to set security information over a wireless network according to another exemplary embodiment of the present invention;

FIG. 4 is a block diagram illustrating an internal structure of a station in a system to set security information over wireless network according to a still another exemplary embodiment of the present invention;

FIG. 5 is a flow chart illustrating a method to set security information over a wireless network according to a still another exemplary embodiment of the present invention; and

FIG. 6 is a flow chart illustrating an operation to perform authentication and create authentication information in a method to set security information over a wireless network according to a still another exemplary embodiment of the present invention.

### DETAILED DESCRIPTION OF EXEMPLARY EMBODIMENTS

Subject matters of other embodiments will be covered by the detailed description and drawings of exemplary embodiments of the present invention.

Aspects of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described in more detail with reference to the accompanying drawings.

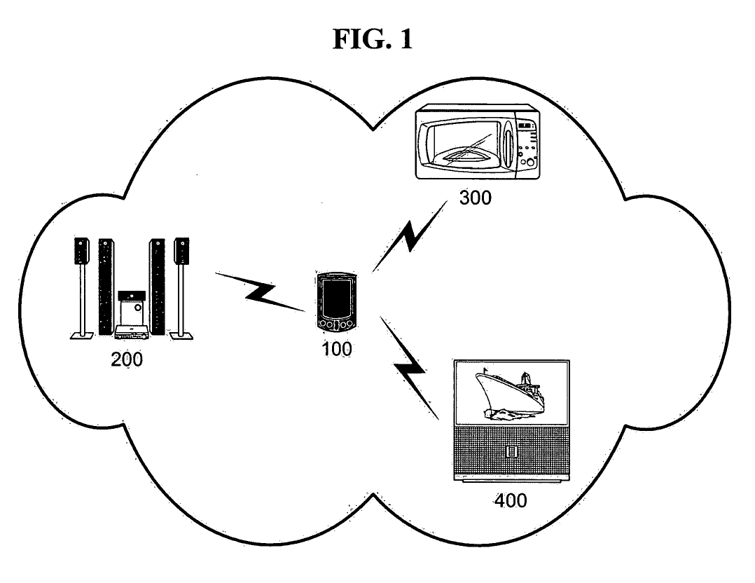

FIG. 1 illustrates a system to set security information in a wireless network according to an exemplary embodiment of the present invention.

Referring to this figure, an access point 200, a plurality of stations 300 and 400, and a key distribution device 100 are present in the wireless network. The access point 200 refers to a network access controlling device capable of controlling access to the wireless network, and the stations 300 and 400 refer to network devices capable of accessing the wireless network and communicating in a wireless manner, such as notebook computers, digital TVs, and set-top boxes.

In this specification, the access point 200 and the stations 300 and 400 will be collectively referred to as “wireless network devices.”

The key distribution device 100 refers to a portable wireless device, such as a cellular phone, a personal digital assistant (PDA), a remote control, or a processor-based smart card.

The key distribution device 100 creates encryption keys based on encryption information input by a user or selected by the access point 200, and distributes the created encryption keys to the wireless network devices 200, 300 and 400. The encryption keys are created with various lengths, so as to be applicable to all the wireless LANs. Here, the term “encryption” refers to, for example, WEP, WPA and advanced encryption standard-counter mode/CBC/MAC protocol (AES-CCMP).

The encryption keys are shared between the wireless network devices 200, 300 and 400 which constitute the wireless network, and thus, any external network device being unaware of the encryption keys cannot participate in the communications.

The key distribution device 100 receives rules associated with authentication information transmitted from the wireless network devices 200, 300 and 400, and creates authentication information using the transmitted rules and proper information of the key distribution device 100, or a random number created by the key distribution device 100.

Then, the key distribution device 100 distributes the created authentication information to the wireless network devices 200, 300 and 400. The created authentication information includes identification information of the wireless network devices 200, 300 and 400, and it is created differently according to each device.

The access point 200 collects and sorts encryption information from the wireless network devices 300 and 400, and transmits the sorted encryption information to the key distribution device 100. Here, the term “encryption information” refers to encryption algorithms used by stations and lengths of the encryption keys.

The access point 200 encrypts and decrypts predetermined data using the encryption key distributed by the key distribution device 100, and it communicates with each of the stations 300 and 400.

In order to receive the security information distributed by the key distribution device 100, the access point 200 checks authentication information so as to ascertain whether the key distribution device 100 having distributed the security information (for example, encryption key and authentication information) has been authenticated, and the access point 200 receives the distributed security information only when it confirms that the key distribution device 100 is an authenticated device.

The station 300 communicates with the access point 200 and the other station 400 by use of the encryption key transmitted from the key distribution device 100.

To receive the security information distributed by the key distribution device 100, the stations 300 and 400 check authentication information so as to ascertain whether the key distribution device 100 having distributed the security information has been authenticated, and they receive the distributed security information only when it is confirmed that the key distribution device 100 is an authenticated device.

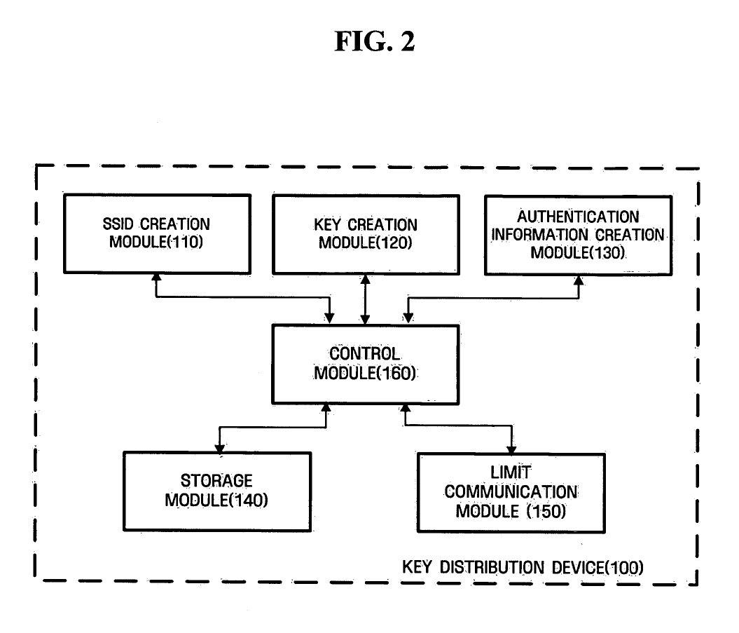

FIG. 2 is a block diagram illustrating an internal structure of a key distribution device for a system to set security information in a wireless network according to an exemplary embodiment of the present invention. The key distribution device 100 comprises an SSID creation module 110, a key creation module 120, an authentication information creation module 130, a storage module 140, a limit communication module 150 and a control module 160.

The SSID creation module 110 creates an SSID to allow the access point 200 and the station 300 present in the same wireless network to communicate with each other. The SSID consists of a series of alphabets to identify any service set, whereby the wireless network devices 200, 300 and 400 present within the same wireless network use the same SSID and they receive the data transmitted only when the same SSID is included in the data.

When no SSIDs are set in the wireless network devices 200, 300 and 400, the key distribution device 100 creates an SSID with a specific length and stores it in the storage module 140, and transmits the created SSID to the wireless network devices 200, 300 and 400.

The key creation module 120 creates an encryption key based on encryption information input by a user or received from the access point 200. Here, the term “encryption information” refers to encryption algorithms used by the wireless network devices 200, 300 and 400, and lengths of encryption keys; the encryption algorithms can include WEP, WPA and AES-CCMP.

For example, when the encryption information received from the access point 200 details the WEP algorithm with a key length of 104 bits, the key creation module 120 creates an encryption key whose length is 104 bits using the WEP algorithm.

The authentication information creation module 130 creates authentication information using rules associated with the authentication information transmitted from the wireless network devices 200, 300 and 400 and proper information of the key distribution device 100 or a random number created by the key distribution device 100.

When any of the wireless network devices 200, 300 and 400 transmit rules of its desired authentication to the key distribution device 100 in a well-defined format such as XML, the key distribution device 100 extracts the rules of authentication from the transmitted description, and create the authentication rules including IDs of the wireless network devices 200, 300 and 400.

For example, where the description transmitted by the wireless network device 300 has a device ID=aaa, a length of authentication information=30 characters, special letters>=3, the key distribution device 100 creates authentication information of the wireless network device 300 using the authentication information rules transmitted and special letters or a random number having the maximum length. Here, the authentication information is created differently by each wireless network device.

The storage module 140 stores SSIDs generated by the SSID creation module 110, the key creation module 120, and the authentication information creation module 130, and security information (e.g., encryption key and authentication information).

The limit communication module 150 receives encryption information sorted and transmitted by the access point 200, and transmits the SSIDs and the security information to the wireless network devices 200, 300 and 400. That is, the limit communication module 150 transceives information data requiring for security.

The limit communication module 150 is a communication module limited in distance and direction so as to allow only the devices present within the same wireless network to communicate; it can use, for example, infrared data association (IrDA), near field communication (NFC), and Bluetooth.

Transmission of the SSIDs and the security information through the limit communication module 150 is to prevent any external device existing in another wireless network from wiretapping the above-described SSIDs, encryption keys, and authentication information.

When the limit communication module 150 receives encryption information of the wireless network devices 200, 300 and 400 transmitted from the access point 200, the control module 160 transmits the received encryption information to the key creation module 120, and controls it so that encryption keys created by the key creation module 120 are transmitted to the wireless network devices 200, 300 and 400 through the limit communication module 150.

The control module 160 ensures that SSIDs and authentication information created by the SSID creation module 110 and the authentication information creation module 130 are transmitted to the wireless network devices 200, 300 and 400 through the limit communication module 150, and that information created by each module, including the SSID, encryption key and authentication information, is stored in the storage module 140.

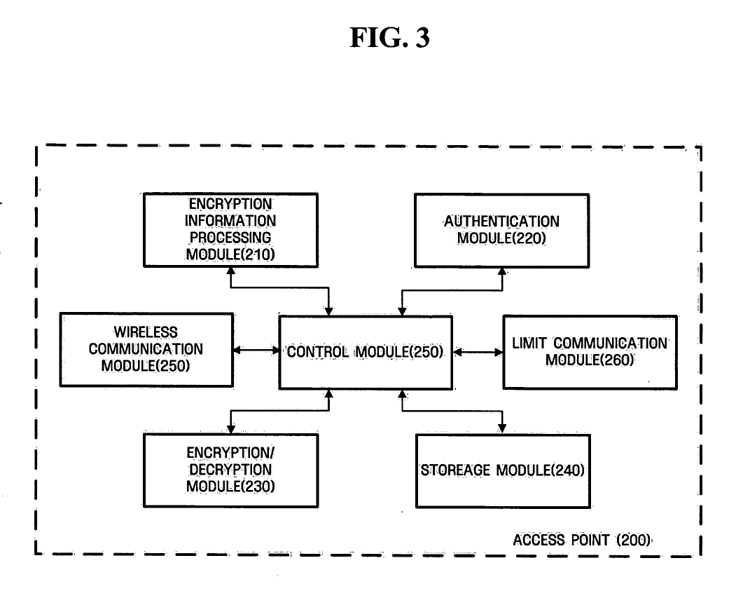

FIG. 3 is a block diagram illustrating an internal structure of an access point in a system to set security information in a wireless network according to another exemplary embodiment of the present invention. The access point 200 comprises an encryption information processing module 210, an authentication module 220, an encryption/decryption module 230, a storage module 240, a wireless communication module 250, a limit communication module 260 and a control module 270.

The encryption information processing module 210 collects encryption information of the wireless network devices 200, 300 and 400, and sorts collected encryption information available by using the wireless network devices 200, 300 and 400. Here, the term “encryption information” refers to encryption algorithms used by the wireless network devices 200, 300 and 400, and lengths of encryption keys; the encryption algorithms may include WEP, WPA and AES-CCMP.

The encryption information processing module 210 selects the most secure encryption information from the collected encryption information, and transmits the selected encryption information to the key distribution device 100. The secure encryption information may be determined according to the length of the encryption key.

The authentication module 220 checks SSIDs and security information transmitted by the key distribution device 100 so as to authenticate the key distribution device 100. Here, the reason why authentication of the key distribution device 100 is checked is to permit only authorized users access.

The authentication module 220 checks whether the key distribution device 100 has been authenticated, through authentication information transmitted when the key distribution device 100 transmits the SSIDs and the encryption key.

The encryption/decryption module 230 encrypts and decrypts predetermined data by means of the encryption keys transmitted by the key distribution device 100. Here, the security of the wireless communications can be enhanced by transmitting data encrypted by the encryption/decryption module 230.

The storage module 240 stores the SSIDs, the security information transmitted by the key distribution device 100, and the collected encryption information.

The wireless communication module 250 transmits data to and receives data from the stations 300 and 400 present within the wireless network. The wireless communication module 250 transceives general data, except for information requiring security, unlike the limit communication module 260.

The limit communication module 260 transmits the sorted encryption information to the key distribution device 100, and receives encryption keys and authentication information transmitted from the key distribution device 100. That is, the limit communication module transceives information requiring security.

Here, the limit communication module 260 is a communication module limited in distance and direction so as to permit only the devices present within the same wireless network to communicate with each other; the limit communication module 260 uses technologies such as infrared data association (IrDA), near field communication (NFC), and Bluetooth.

Transmission of the sorted encryption information through the limit communication module 260 is to prevent any external device in another wireless network from wiretapping the sorted encryption information.

The control module 270 ensures that the encryption information processing module 210 sends the sorted encryption information to the key distribution device 100 through the limit communication module 260, the encryption keys and authentication information sent by the key distribution device 100 are stored in the storage module 240, and data encrypted or decrypted through the encryption/decryption module 230 is sent to a concerned station through the wireless communication module 250.

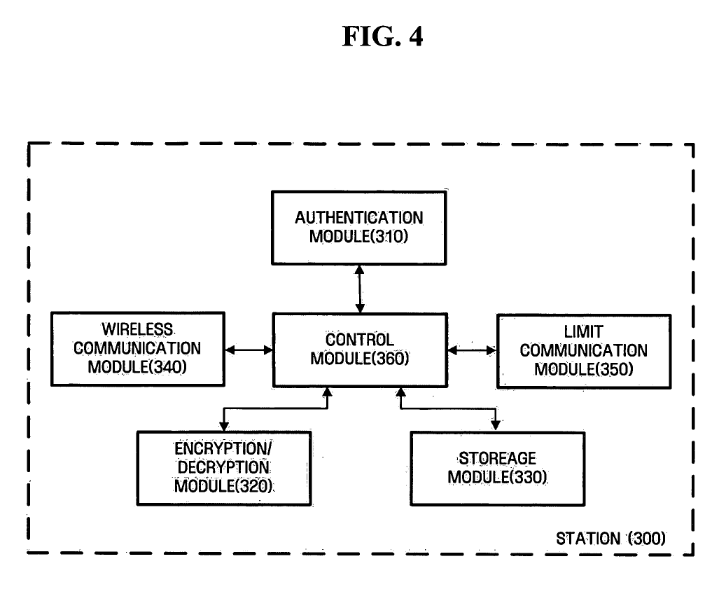

FIG. 4 is a block diagram illustrating an internal structure of a station in a system to set security information in a wireless network according to another exemplary embodiment of the present invention. The station 300 comprises an authentication module 310, an encryption/decryption module 320, a storage module 330, a wireless communication module 340, a limit communication module 350 and a control module 360.

The authentication module 310 checks whether the key distribution device 100 has been authenticated. A reason to check the authentication of the key distribution device 100 is to permit only authorized users access.

The authentication module 310 checks authentication of the key distribution device 100 through authentication information transmitted when the key distribution device 100 transmits the SSIDs and the encryption keys.

The encryption/decryption module 320 encrypts and decrypts predetermined data using the encryption keys transmitted by the key distribution device 100.

The wireless communication module 340 transmits data to and receives data from the access point 100 and the other station 400 present in the same wireless network. The wireless communication module 350 transceives general data, except for information requiring security, unlike the limit communication module 340.

The limit communication module 260 transmits rules associated with authentication information to the key distribution device 100, and receives encryption keys and authentication information transmitted by the key distribution device 100. That is, the limit communication module transceives information requiring security.

Here, the limit communication module 350 is a communication module limited in distance and direction so as to allow only the devices present within the same wireless network to communicate with each other; the limit communication module 350 uses technologies such as infrared data association (IrDA), near field communication (NFC), and Bluetooth.

The control module 360 ensures that the authentication information rules of the station 300 are sent to the key distribution device 100 through the limit communication module 350, the encryption keys and authentication information sent by the key distribution device 100 are stored in the storage module 330, and data encrypted or decrypted through the encryption/decryption module 320 is sent to a concerned station and the access point 200 through the wireless communication module 340.

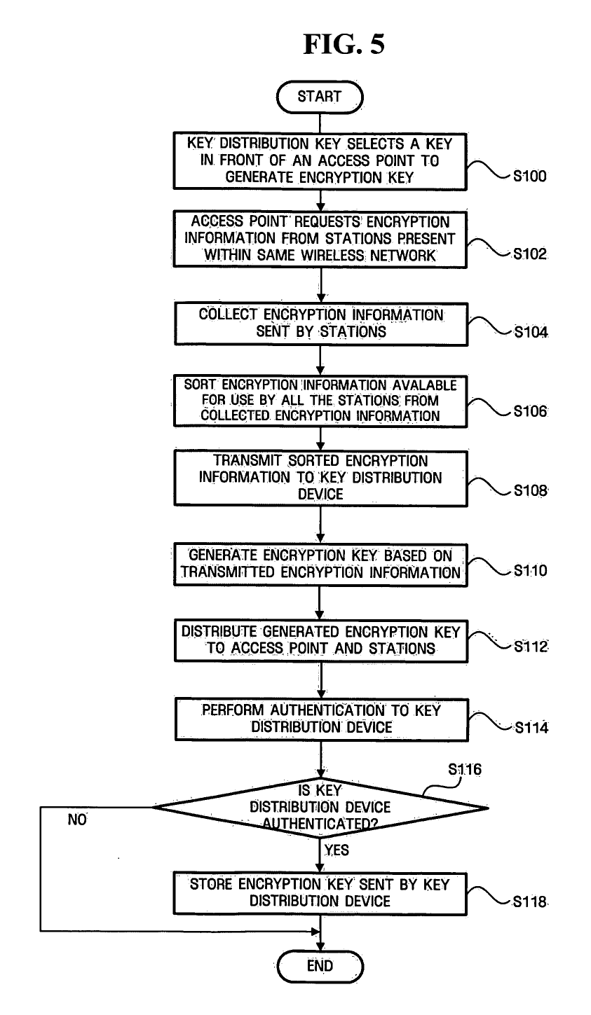

FIG. 5 is a flow chart illustrating a method of setting security information in a wireless network according to a still another exemplary embodiment of the present invention. The key distribution device 100, the access point 200, and a plurality of stations 300 and 400 are present in the wireless network.

To create respective encryption keys of the wireless network devices 200, 300 and 400, the key distribution device 100 selects keys when positioned in front of the access point 200 S100.

Here, it is assumed that the wireless network devices 200, 300 and 400 have their own SSIDS.

When the wireless network devices 200, 300 and 400 do not have the SSIDs, the key distribution device 100 generates SSIDS, and distributes the generated SSIDs to the wireless network devices 200, 300 and 400. Here, an SSID consists of rows of letters to identify service sets, and the wireless network devices 200, 300 and 400 present within the same wireless network use the same SSIDs.

When the key distribution device 100 distributes SSIDs to the wireless network devices 200, 300 and 400, authentication information to authenticate the key distribution device 100 is also sent, thereby allowing the wireless network devices 200, 300 and 400 to authenticate the key distribution device 100.

Then, when a key is selected by the key distribution device 100, the access point 200 requests encryption information from the stations 300 and 400, through the wireless communication module 250 S102. Here, the term “encryption information” refers to encryption algorithms used by the wireless network devices 200, 300 and 400, and lengths of encryption keys.

Following this, the access point 200 receives encryption information sent by the stations 300 and 400 through the wireless communication module 250, and the encryption information processing module 210 collects encryption information of the stations 300 and 400 S104.

The encryption information processing module 210 sorts the collected encryption information S106, and selects the most secure encryption information from the sorted encryption information.

The access point 200 sends the selected encryption information to the key distribution device 100 through the limit communication module 260 S108. Here, the limit communication module 260 uses technologies such as infrared data association (IrDA), near field communication (NFC), or Bluetooth. Transmission of the selected encryption information through the limit communication module 150 is to prevent any external device in another wireless network from wiretapping the selected encryption information.

The limit communication module 150 of the key distribution device 100 receives encryption information sent by the access point 200, and the key creation module 120 creates encryption keys based on the received encryption information S110.

For example, when the encryption information sent from the access point 200 details the WEP algorithm with 104 bits, the key creation module 120 of the key distribution device 100 creates encryption keys whose lengths are 104 bits based on the WEP algorithm. Here, the encryption keys created are different in length every time, and they can be applied to all of the wireless LANs and the security of the wireless communication can be enhanced.

The created encryption keys are distributed to the wireless network devices 200, 300 and 400 through the limit communication module 150 S112. By distributing the encryption keys through the limit communication module 150, any external device existing in another network cannot receive the encryption keys.

When the encryption keys are sent by the key distribution device 100, the wireless network devices 200, 300 and 400 check whether the key distribution device 100 has been authenticated, through the authentication modules 220 and 310, to thereby ascertain whether the key distribution device 100 is a device used by an authorized user S114.

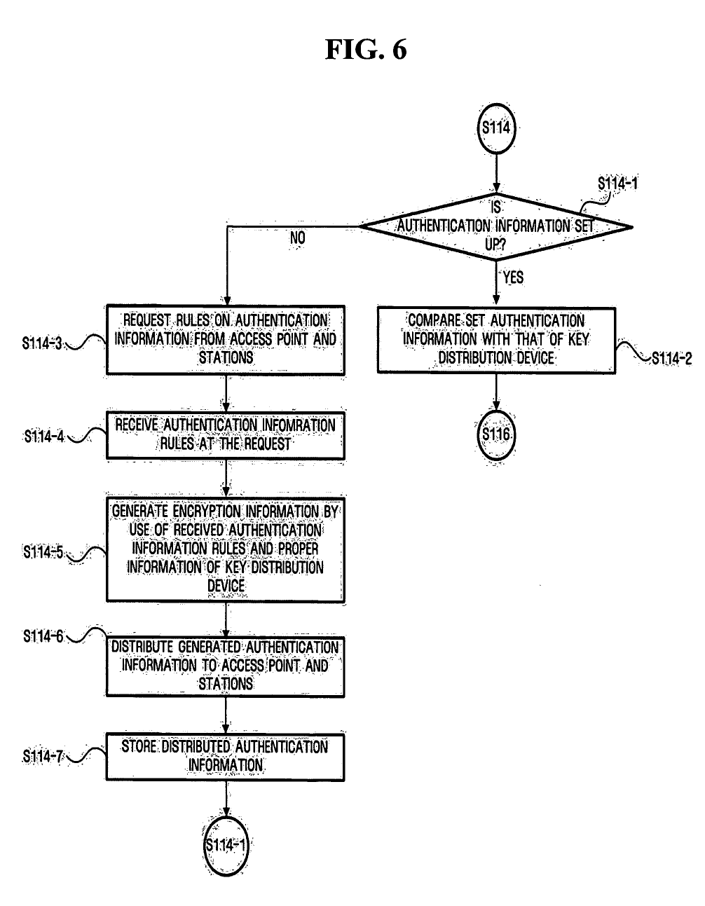

To authenticate the key distribution device 100, authentication information has to be set in the wireless network devices 200, 300 and 400. Here, it is assumed that the authentication information has been set in the wireless network devices 200, 300 and 400. An operation of performing authentication and creating authentication information will be described with reference to FIG. 6.

The authentication modules 220 and 310 of the wireless network devices 200 and 300, respectively, compare their authentication information with that of the key distribution device 100 to check the identity of the key distribution device 100, and as a result of checking, determine whether they are identical S116. The key distribution device 100 sends the authentication information with the encryption keys.

When it is determined that they are the same, that is, the key distribution device 100 is an authenticated device, the wireless network devices 200, 300 and 400 store the encryption keys sent by the key distribution device S118.

The wireless networking devices 200, 300 and 400 encrypt and decrypt the predetermined data by use of the stored encryption keys, and then conduct communications. Accordingly, since any external key being unaware of the encryption keys cannot decrypt the encrypted data, the security of specific data can be maintained.

When it is determined that the authentication information is not identical, that is, the key distribution device 100 has not been authenticated, the wireless network devices 200, 300 and 400 delete the encryption keys sent by the key distribution device 100.

Since the key distribution device 100 creates encryption keys based on the sorted encryption information, and then distributes them to the wireless network devices 200, 300 and 400 through the limit communication module 150, any device in another network cannot wiretap information, thereby enabling secure wireless communications.

FIG. 6 is a flow chart illustrating an operation to perform authentication and create authentication information in a method to set security information in a wireless network according to a still another exemplary embodiment of the present invention.

To check whether the key distribution device 100 has been authenticated, it is first checked whether authentication information is set in the wireless network devices 200, 300 and 400 S114-1.

When it is confirmed that the authentication information is set, the authentication modules 220 and 310 compare their authentication information with that of the key distribution device 100, in order to check whether they are identical S114-2.

According to the identity of the authentication information, the encryption keys distributed by the key distribution device 100 are stored or deleted S116 and S118.

When it is confirmed that the authentication information is not set in the wireless network devices 200, 300 and 400, the key distribution device 100 requests rules associated with the authentication information from the wireless network devices 200, 300 and 400 S114-3.

When a description including the authentication rules is sent from the wireless network devices 200, 300 and 400 S114-4, the authentication information creation module 130 of the key distribution device 100 extracts the authentication rules from the received description and creates authentication information using the extracted authentication information rules and proper information of the key distribution device 100, or a random number created by the key distribution device 100 S114-5.

For example, when the description transmitted by the wireless network device 300 has a device ID=aaa, a length of authentication information=30, special letters>=3, the key distribution device 100 creates authentication information of the wireless network device 300 by use of the authentication information rules transmitted and special letters, or a random number having the maximum length.

Since the created authentication information includes IDs of the wireless network devices 200, 300 and 400, the wireless network devices 200, 300 and 400 have different authentication information.

The key distribution device 100 distributes the created authentication information to the wireless network devices 200, 300 and 400 through the limit communication module 150 S114-6, and the wireless network devices 200, 300 and 400 store the distributed authentication information S114-7.

An exemplary embodiment to distribute encryption keys by means of a portable device will be described. Here, it is assumed that the key distribution device 100 is a PDA, the access point is a TV, and the stations can be an audio device and a computer. The PDA is just an example of portable wireless devices, and any other portable wireless devices (e.g., a cellular phones) are also covered by this embodiment of the present invention.

To generate encryption keys, if a user selects a key of the PDA in front of the TV, the TV collects encryption information about the audio device and the computer, sorts the information and selects the most secure encryption information from the encryption information of the TV, audio device and computer, and then sends it to the PDA.

The PDA uses the received encryption information and generates encryption keys available for use by the TV, audio device and computer.

Then, the PDA distributes the generated encryption keys to the TV, audio device and computer. Here, in an encryption key distribution method, when the user selects a specific key of the PDA in front of the TV, an encryption key is created and stored in the PDA, and it is sent to the TV. Also, when the user selects a specific key of the PDA in front of the audio device, an encryption key that has been created and stored in the PDA is sent to the audio device. When the user selects a specific key of the PDA in front of the computer, an encryption key that has been created and stored in the PDA is sent to the computer.

By allowing a user to set security information (e.g., encryption keys) of the wireless network devices using portable devices (e.g., a PDA), the security information can be more conveniently set. Also, by sending the security information in front of a concerned device, there is no risk that other external device will receive the security information, thereby enhancing the security in communications.

An apparatus, system and method of setting security information in the wireless network according to an exemplary embodiment of the present invention as described above produces at least one of the following exemplary effects.

First, the security in wireless communications transceived within the wireless network is enhanced by generating encryption keys and authentication information by means of a portable device and distributing the generated encryption keys and authentication information to the wireless network devices.

Second, a user can more conveniently set the security information since he/she is allowed to set the security information of the wireless network devices by means of a portable device.

Third, a user can manage wireless network devices without memorizing the security information, but by providing it by means of a portable device which can be conveniently used by the user.

Fourth, encryption keys can be used in all of the wireless networks since they can be generated through various algorithms and can have various key lengths.

Fifth, any wireless network device present in the other wireless network cannot wiretap the transceived security information because only wireless network devices present within the same wireless network can transceive data through specifically limited communications.

Those of ordinary skill in the art can understand that various replacements, modifications and changes in form and details may be made therein without departing from the spirit and scope of the present invention as defined by the following claims. Therefore, it is to be appreciated that the above described exemplary embodiments are for purposes of illustration only and not to be construed as a limitations of the invention.

What is claimed is:

1. An apparatus for setting security information in a wireless network, comprising:
a limit communication module which receives first encryption information sorted by an access point;
a key creation module which creates encryption keys based on one of the received first encryption information and second encryption information input by a user; and
an authentication information creation module which creates first authentication information according to rules associated with second authentication information sent by at least one of the access point and stations.

2. The apparatus of claim 1, wherein the limit communication module sends at least one of the created encryption keys and authentication information to the access point and at least one of the stations.

3. The apparatus of claim 1, further comprising:
an SSID creation module which generates service set identifiers (SSIDs) that allow the access point and stations present within the same wireless network to communicate with each other; and
a storage module which stores the created encryption keys and authentication information.

4. A system for setting security information in a wireless network, comprising:
an access point which communicates with stations in the wireless network, and collects and sorts first encryption information of the stations;
a key distribution device which creates encryption keys based on the first encryption information sorted by the access point, and distributes the generated encryption keys; and
at least one of said stations which communicates using at least one of said encryption keys received from the key distribution device.

5. The system of claim 4, wherein the access point comprises:
an encryption information processing module which collects encryption information of the stations present within the wireless network, and sorts encryption information available for use by all the stations from the collected encryption information; and
a limit communication module which sends the sorted encryption information to the key distribution device, and receives the encryption keys sent by the key distribution device.

6. The system of claim 4, wherein the key distribution device comprises:
a limit communication module which receives the encryption information sorted by the access point;
a key creation module which creates encryption keys based on one of the received first encryption information and second encryption information input by a user;
an authentication information creation module which creates first authentication information according to rules associated with the second authentication information sent by the access point and the stations;
an service set identifier (SSID) creation module which creates SSIDs so as to allow the access point and the stations within the same wireless network to communicate with each other; and
a storage module which stores at least one of the created encryption keys and authentication information.

7. A method of setting security information in a wireless network, comprising:
receiving encryption information from an access point;
creating encryption keys based on the received encryption information;
distributing the generated encryption keys to the access point and stations; and
setting the security information with the distributed encryption keys.

8. The method of claim 7, further comprising:
the access point requesting the security information from the stations existing within the wireless network;
sorting encryption information available for use by all the stations from the encryption information received at request; and
transmitting the sorted encryption information to a key distribution device.

9. The method of claim 7, further comprising:
receiving the encryption keys distributed by a key distribution device; and
performing authentication of the key distribution device that sent the encryption keys.

10. The method of claim 9, wherein authentication of the key distribution device that sent the encryption keys comprises:
determining whether authentication information is set in the access point and the stations;
checking the identity detailed in the set authentication information, which is stored in the key distribution device, and performing the authentication when the authentication information is set;
the key distribution device creating authentication information when the authentication information is not set; and
distributing the generated authentication information to the access point and the stations and setting the authentication information.

11. The method of claim 10, wherein the authentication information is created using one of: (1) authentication information rules sent by the access point and the stations and other information, and (2) a random number of the key distribution device.
